(19) United States
(12) Patent Application Publication
(10) Pub. No.: US 2025/0149877 A1
(43) Pub. Date: May 8, 2025

(54) CONTROL DEVICE

(71) Applicant: SITEMA GmbH & Co. KG, Karlsruhe (DE)

(72) Inventors: Thomas Haase, Steinweiler (DE); Andreas Kiss, Wallbach (CH)

(73) Assignee: SITEMA GmbH & Co. KG, Karlsruhe (DE)

(21) Appl. No.: 18/936,063

(22) Filed: Nov. 4, 2024

(30) Foreign Application Priority Data
Nov. 2, 2023 (DE) 102023130356.2

(51) Int. Cl. H02H 7/08

(52) U.S. Cl. CPC H02H 7/0844; H02H 7/0838

(57) ABSTRACT

A control device for fail-safe control of an electric actuator, having: an electrical power source; a power path from the source to an output connection for an actuator, in which a power part is arranged. The power part switches the polarity of the output voltage and/or changes the amount of electrical power that is output. A power switching element in the path switches the electrical power at the output on and off. A sensor downstream of the power part determines the electrical power at the output. An enable signal actuates the power switching element, and a switching signal provides the electrical power at the output based on a switching state. A combinational circuit logic assembly carries out logic operations between the switching state of the switching signal and the electrical power determined by the sensor and generates a further enable signal used to act on the power switching element.

### CROSS-REFERENCE TO RELATED APPLICATIONS

This application claims priority from German Patent Application No. 10 2023 130 356.2, filed Nov. 2, 2023, which is incorporate herein by reference as if fully set forth.

### TECHNICAL FIELD

The invention relates to a control device for the fail-safe control of an electric actuator.

The invention also relates to a system including a control device according to the invention and of an actuator, in particular an electric motor for moving a machine part, preferably a braking or clamping element, connected to the output connection.

### BACKGROUND

EP 2 845 072 B1 discloses a (compact) control device and a system composed of such a control device and of an actuator for moving a machine part, in which the safety functions are provided via software or firmware and via a redundant microcontroller (μC) architecture.

Considered particularly disadvantageous here is that there are no safety measures which are realized without use of the microcontroller. This inevitably results in a loss of time due to dead times and program runtimes since all of the switching signals run via the microcontroller. This can be a significant disadvantage in safety-relevant applications. Moreover, the source code used constitutes a source of error which can lead to failure of the system, and internal system diagnostics (without μC involvement) are not provided.

### SUMMARY

The invention is based on the object of specifying a control device and a system in the form of such a control device and of an actuator, which overcomes the above-mentioned disadvantages and in particular operates more safely and without losses of time due to dead times and program runtimes. Furthermore, sources of error which can lead to failure of the device or system should be avoided in order to allow or to improve the use thereof in safety-relevant applications.

This object is achieved according to the invention by a control device having one or more of the features disclosed herein, and by a system having one or more of the features related to such a control device and of an actuator connected to an output connection of the control device.

Advantageous developments of these subjects according to the invention are described below and in the claims.

According to the invention, a control device for the fail-safe control of an electric actuator has a source of electrical power. There is at least one power path from the source of electrical power to an output connection for an actuator, in which power path at least one power part is arranged. This power part is designed to switch the polarity of a voltage present at the output connection and/or to change the amount of an electrical power provided at the output connection. In the power path at least one power switching element, preferably a normally open switching element, is additionally arranged, which power switching element in its initial state thus interrupts the power path. The power switching element is designed to switch the electrical power provided at the output connection on and off. Moreover, the control device comprises at least one sensor means which is arranged downstream of the power switching element in order to determine the electrical power currently provided at the output connection. Moreover, the control device additionally comprises a first signal input for an enable signal for actuating the power switching element and a second signal input for a switching signal for providing the electrical power at the output connection on the basis of a switching state of the enable signal. Furthermore, the control device comprises at least one software-free electrical logic assembly in the form of a combinational circuit (see, e.g., Grafendorfer, W. (1977). Schaltwerke und Schaltnetze [Sequential Circuits and Combinational Circuits]. In: Einführung in die Datenverarbeitung für Informatiker [Introduction to Data Processing for Computer Scientists]. Physica paperback. Physica, Heidelberg, which is designed to carry out logic operations between the switching state of the switching signal and the electrical power determined by the sensor means and consequently to generate at least one further enable signal. This further enable signal is able to be used to act on the at least one power switching element or can be used to act on the at least one power switching element.

The system according to the invention comprises a control device according to the invention and an actuator, in particular an electric motor for moving a machine part, preferably a braking or clamping element, connected to the output connection.

The control device according to the invention accordingly implements safety-relevant functions without the significant use of a microcontroller with corresponding software/firmware, as a result of which the above-mentioned disadvantages are avoided. By virtue of the provision of the enable signal, of the switching signal, and the determination of the electrical power performed by the sensor means, in addition to generation of at least one further enable signal based on logic operations between the switching state of the switching signal and the determined electrical power, the proper functioning of the control device can be checked quickly, continuously and reliably, which is indispensably or at least highly advantageous in the case of safety-relevant use.

In this way, the present invention also overcomes the lack of feedback information, which is problematic for safety reasons in the prior art, for diagnosing the functionality and freedom from faults of the power path: In the scope of the invention, it is possible to compare current flow or output power with a switching state of the control signal without using a microcontroller. As a result, it can be advantageously ensured that no current flows or no power is output if no corresponding control signal is present.

On account of the provision of an enable signal separate from switching signal, the control device can be “switched off” by a superordinate control unit, e.g. a programmable logic controller (PLC). This overcomes an inherent disadvantage of the prior art, in particular according to EP 2 845 072 B1, in which no such separation between enable signal and switching signal exists. Figuratively speaking, this is equivalent to a safety door which also takes over the robot control at the same time. In the prior art, the control signal is connected directly to the power switching element and so faults on the control signal have a direct impact on the control of the actuator system.

Unlike in the prior art, in the scope of the present invention physical separation between the actuator system (i.e. an actuator connected to the control device) and the control device can be established (by means of the power switching element) in order to increase the operational safety.

The following further developments of the fundamental idea according to the invention have proven to be particularly advantageous:

In one development of the control device according to the invention, the electrical power at the output connection is only switched on or able to be switched on when both the enable signal and the further enable signal each command a corresponding switching state of the power switching element, that is to say in particular closing of the power switching element.

In this way, it is possible to avoid, e.g., power being output at the output connection when the sensor means registers a current flow while the enable signal has no corresponding switching state, which indicates a case of a fault.

In another development of the control device according to the invention, the power switching element is in the form of at least one electromechanically, electrically or purely mechanically operative separating element which is integrated into the power path and is preferably implemented with redundance. In particular, the separating element can be implemented as a contactor, relay or solid-state relay. It serves to interrupt a power supply to the output connection. In this case, the at least one separating element is able to be monitored with respect to its switching state or its functioning from outside the control device by at least one downstream sensor means by virtue of relevant sensor connections being led out from the control device to the outside.

This additionally contributes to a further increase in the functional safety of the control device.

In yet another development of the control device according to the invention, the latter comprises at least one in particular digital evaluation unit (a microcontroller) which is designed to receive the switching signal and a corresponding switching time (that is to say a change in state of the switching signal). The control device is furthermore designed to provide the power with a predefined temporal profile at the output connection and to generate at least one more additional enable signal on the basis of an operating state of the evaluation unit. The additional enable signal is able to be used to act on the at least one power switching element.

In this context, it is important that the integrated microcontroller processes exclusively non-safety-relevant functions. It is involved in the safety functionality exclusively with an enable signal (additional to the mentioned enable signal) in the power path.

In order to increase the operational safety yet further, in one development of the control device according to the invention provision can additionally be made for the electrical power at the output connection to only be switched on or able to be switched on when both the enable signal and the further enable signal as well as the additional enable signal each command a corresponding switching state of the power switching element. Power can thus only be output when the evaluation unit indicates its operational readiness.

In yet another development of the control device according to the invention, the evaluation unit is designed to process exclusively non-safety-relevant functions, in particular by means of software and/or algorithms. The functions implemented by software and/or algorithms are preferably able to be deactivated at any time by taking away the enable signal (i.e. setting the relevant signal to 0 (LOW)) and are thus irrelevant when considering the functional system safety.

The fundamental advantages of the invention can thus be obtained without completely dispensing with the quite advantageous use of a digital evaluation unit with corresponding software/algorithms.

In yet another development of the control device according to the invention, the evaluation unit is designed to generate the one more additional enable signal, in particular by means of software and/or algorithms, in order to signal (e.g. by outputting a corresponding fault signal) operational readiness and/or, by switching off the power, cases of faults.

This allows a sort of “self-diagnosis” and the evaluation of particular sensor data, e.g. detecting defective position sensors for the actuator or a (machine) part moved by the actuator, of an integrated temperature sensor for signaling excessive temperature, detecting failure of the energy supply (grid voltage), detecting faulty parameters in the software itself, e.g. no parameters programmed for a clamping unit, or indicating a maintenance notification. The fault signal communicates the corresponding data to the outside to the user; the above-mentioned internal signal (the additional enable signal) allows corresponding “internal” communication inside the control device.

A corresponding development of the control device according to the invention therefore makes provision for the evaluation unit to be designed to generate at least one further signal, in particular by means of software and/or algorithms, and to provide it to a relevant output in order to make any faults, for example a defective sensor means, a maintenance state or state monitoring, available outside the control device. Reference has already been made to this further above.

In yet another configuration of the control device according to the invention, the evaluation unit is designed to act on the power part, in particular in accordance with the switching signal, in order to generate by means of the power part a time-dependent power to be provided at the output connection. This time-dependent power is preferably able to be used to transfer the actuator (or a (machine) part moved by the actuator) into at least one target position and to subsequently hold it in the target position.

The switching signal advantageously only has the values 0 (LOW) or 1 (HIGH) and thus signals a time at which the actuator or the machine part should be moved, e.g. at which a brake should be opened or closed. The actuator or the brake is then transferred into the desired state. For this purpose, regularly at short notice a relatively large amount and then no (brake is closed) or only still a relatively small amount (brake is kept open) of power is necessary. As a result, the (required) power is temporally variable. Technically, the time during which the actuator is driven with more power than it can thermally tolerate on a sustained basis is referred to as overexcitation. Example: In order to open a particular clamping unit from the program of the applicant, a power of 2 KW is required for approx. 0.3 seconds in order to transfer the relevant motor; then only still about 5 W in order to hold the motor in the relevant position. This time dependency of the power can be realized in particular through suitable temporally variable control of the power part by means of the evaluation unit (controller unit or microcontroller). A time-dependent power or overexcitation of this kind can be provided direction-independently for transferring the actuator/motor into any target position and thereby provides support in particular even when the actuator is demagnetized. This active demagnetization allows a controlled high-speed switching off of the/a brake or of another (safety-relevant) component on which the actuator acts.

In yet another configuration of the control device according to the invention, at least one external connection operatively connected to the evaluation unit is present in order to program and/or to parametrize the evaluation unit, preferably with the aid of software, via the external connections. This allows the time-dependent power to be adjusted, preferably in coordination with a connected actuator, in order to allow the actuator to be switched on and switched off in an application-specific manner, for example with regard to necessary switching times.

This has already been explained by way of example further above. The invention is of course not limited to such applications.

In yet another configuration of the control device according to the invention, at least one input connection for reading in and capturing a position signal is present. This position signal preferably indicates an actual position of the actuator, in order to generate the already mentioned further signal on the basis thereof. This further signal can preferably be used for internal switching time evaluations, wear determination and indications of freedom from faults of the (position) sensor system.

In yet another configuration of the control device according to the invention, at least two input connections for reading in and capturing two position signals are present. The two position signals or the correspondingly present position sensors preferably indicate an actual position of the actuator with redundance. The evaluation unit is correspondingly designed to generate the further signal on the basis of a logical combination, in particular an XOR combination or an XNOR combination, of switching states of the two position signals.

In this way, the proper functioning of the position sensors (Sensor1, Sensor2) can be monitored in a simple way: If Signal(Sensor1)=1 (HIGH), it must be that Signal(Sensor2)=0 (LOW), for example. If Signal(Sensor1)=0 (LOW), it must be that Signal(Sensor2)=1 (HIGH). The sensors can thus be identical but always have to deliver the opposite sensor values (0/1 or 1/0). If the case occurs whereby both values are 0 or 1, one of the sensors is broken and a corresponding fault message is output. The same effect can also be achieved if both sensors are connected in such a way that they always have to indicate the same value in the normal state.

In another development of the control device according to the invention, at least one external connection for tapping internally generated voltages for the external analysis of a voltage supply and/or voltage conversion within the control device is present.

This makes it possible to monitor whether the voltage supply and conversion is operating fault-free.

In another development of the control device according to the invention, the power part comprises an H-bridge circuit or an H bridge with semiconductor switches.

Such circuits are known per se to the person skilled in the art. They basically consist, in the case of an electronic H-bridge circuit, of four semiconductor switches, in most cases of transistors, which can convert a DC voltage into an AC voltage of variable frequency.

In yet another development of the control device according to the invention, the power part for controlling a three-phase actuator is designed such that it comprises a triple H-bridge circuit or a triple H bridge with semiconductor switches.

In yet another development of the control device according to the invention, the power switching element is connected between the power part and the output connection.

It thus serves to allow or to interrupt the power supply from the power part to the output connection in a simple way.

In another development of the control device according to the invention, the latter additionally possesses a third signal input for a further switching signal for activating or deactivating the power part.

In this way, a further increase in the operational safety of the control device is additionally achieved.

Finally, another development of the control device according to the invention additionally makes provision for the input connection or the input connections to be designed to duplicate the position signal of a respectively connected position sensor in order to make the duplicated position signal available for an external control unit.

In this way, the one or more position signals can also be evaluated and used by a superordinate controller (e.g. a programmable logic controller (PLC)).

Moreover, the position sensor data can also be evaluated internally for other purposes (e.g. lifetime counter, switching time analysis, etc.).

A corresponding advantageous development of the system according to the invention contains an external control unit, in particular a programmable logic controller (PLC), operatively connected to the control device for providing the enable signal to the first signal input and the switching signal to the second signal input. The PLC can also serve or be designed to provide a further (fourth) enable signal to the third signal input and/or to read out the one or more duplicated position signals. Further interactions between the PLC and control device emerge from the description of the figures.

The control device according to the invention allows integrated switching-state monitoring via inductance measurements in the connected actuator system. The monitoring is made possible by the sensor means present in the power path. A superposed frequency (small signal) on the output voltage (at the output connection) and the resulting frequency on the current signal (amplitude, phase shift) makes inductance measurements possible. The inductance is deviation-dependent depending on the application and actuator and allows assertions to be made about a state of a connected actuator, e.g. about a braking state (open/closed). This information about the inductance is thus equivalent to the switching-state information of the connected position sensor data and can be used accordingly for evaluation purposes.

### BRIEF DESCRIPTION OF THE DRAWINGS

Further properties and advantages of the invention emerge from the following description of the figures on the basis of the drawing.

FIG. 1 shows a high-level circuit diagram of a control device according to the invention;

FIG. 2 shows a more detailed circuit diagram of a control device according to the invention with a connected actuator;

FIG. 3 shows a more detailed circuit diagram of a further control device according to the invention with a connected actuator; and

FIG. 4 shows a more detailed circuit diagram of yet a further control device according to the invention with a connected actuator.

### DETAILED DESCRIPTION

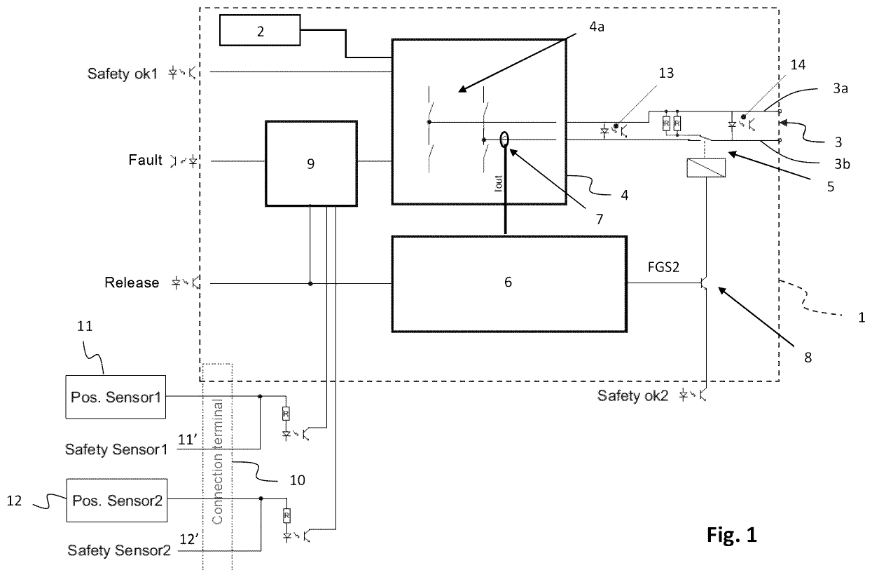

FIG. 1 illustrates a high-level circuit diagram of a control device 1 according to the invention. The control device is as a whole denoted by the reference sign 1 and symbolized by a dashed line (rectangle). It comprises a source of electrical power 2 which can be operatively connected to an external grid voltage (not shown). There is at least one power path from the source of electrical power 2 to an output connection 3 for an actuator (not illustrated in FIG. 1). Arranged in this power path is at least one power part 4 which in FIG. 1, without this being limiting, is in the form of an H-bridge circuit 4a composed of semiconductor switching elements (solid-state relays). This power part is designed to switch the polarity of a voltage, present at the output connection 3, for the actuator and/or to change the amount of an electrical power provided at the output connection 3. Additionally arranged in the power path is at least one power switching element 5 which in the present case is in the form of a normally open switching element, in particular an electromechanical relay, which in its initial state interrupts the power path. The power switching element 5 is designed to switch the electrical power provided at the output connection 3 on and off.

Moreover, the control device 1 comprises a monitoring circuit 6 and at least one sensor means 7, shown only symbolically, which, differing from the illustration in FIG. 1, can also be arranged downstream of the power switching element 5 in order to determine the electrical power, or a corresponding current flow, currently provided at the output connection 3.

Moreover, the control device 1 additionally comprises a first signal input for an enable signal “Safety ok2” for actuating the power switching element 5 and a second signal input for a switching signal “Release” for providing the electrical power at the output connection on the basis of a switching state of the enable signal. The switching signal is applied to the monitoring circuit 6 and is compared there with a sensor signal “Iout” from the sensor means 7 by means of hardware: If a current flows (Iout>0), i.e. power is output at the output connection 3, while the switching signal does not possess the appropriate associated switching state, the monitoring circuit 6 detects a fault and separates the output, i.e. the power switching element 5 separates the power part 4 from the output connection 3.

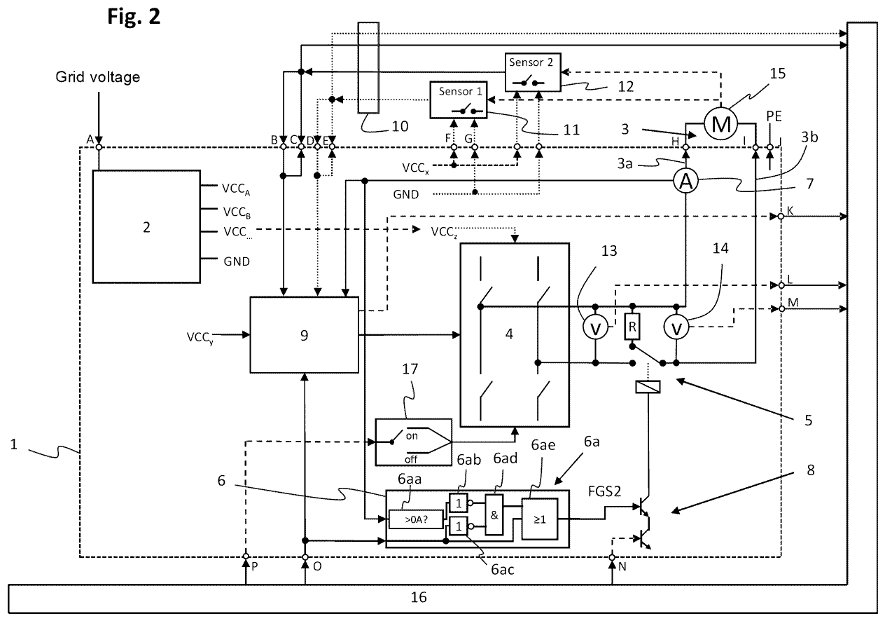

The monitoring circuit 6 comprises at least one software-free electrical logic assembly in the form of a combinational circuit (see, e.g., the definition in Grafendorfer, W. (1977). Schaltwerke und Schaltnetze [Sequential Circuits and Combinational Circuits]. In: Einführung in die Datenverarbeitung für Informatiker [Introduction to Data Processing for Computer Scientists]. Physica paperback. Physica, Heidelberg), cf. in particular FIG. 2. This is designed to carry out logic operations between the switching state of the switching signal and the electrical power determined by the sensor means and consequently to generate at least one further enable signal. This further enable signal is denoted by FGS2 in FIG. 1. This further enable signal FGS2 is able to be used to act on the power switching element 5 via a switching means 8 (in the present case a transistor to which the enable signal is also applied).

Reference sign 9 denotes an evaluation unit in the form of a microcontroller which in particular receives the switching signal and controls the power part 4 accordingly in order to provide power at the output connection 3, preferably time-dependently, i.e. the power in terms of amount (and with regard to its “direction”, that is to say a polarity of the relevant voltage or current flow direction) is dependent on a length of time since the switching signal “Release” was applied and is thereby preferably temporally variable.

The microcontroller 9 outputs a further signal in the form of a fault signal “Fault” if, e.g., the power source 2 is not operationally ready.

The signal “Safety ok1” is a further enable signal (in the present case also referred to as “fourth enable signal”) for activating or deactivating the power part 4.

Two, preferably identically designed, position sensors 11, 12 for an actuator, i.e. for detecting a place or position of the actuator, are operatively connected to the microcontroller 9, and correspondingly to the control device 1, via a connection terminal 10. The output signal of each position sensor 11, 12 is duplicated and output at reference signs 11′ and 12′, respectively (as “Safety Sensor1” and “Safety Sensor2”, respectively).

The further sensor means 13, 14 are arranged downstream of the power part 4, namely upstream and downstream of the power switching element 5, respectively. They detect the presence of a voltage between the two output conductors 3a and 3b. In the present case, both sensor means 13, 14—without this being limiting—are designed in such a way that they are active when no voltage is present between 3a and 3b. The relevant sensor signals are, in contrast with the illustration in FIG. 1, in particular also available outside the control device 1. For this, both sensor signals are preferably—without this being limiting—led to the outside via optocouplers in an electrically isolated manner.

The signal input into the control device 1 and the signal output out of the control device 1 can in principle—without this being limiting—be performed via photodiodes and phototransistors (optocouplers), as illustrated. This is known to the person skilled in the art per se and does not have to be explained further here.

The control device 1 described above is designed such that power is only output at the output connection 3 when both the enable signal “Safety ok2” and the further enable signal FGS2, which is generated by the monitoring circuit 6 by way of logical combination on the basis of the switching signal (“Release”) and the current flow Iout measured by the sensor means 7, each command a corresponding switching state of the power switching element 5. Specifically, the further enable signal FGS2 will not command such a switching state of the power switching element 5 when, despite a switching signal not being present (e.g. Release=0 (LOW)), a current flow is measured by the sensor means 7 (Iout≠0). The enable signal FGS2 then ensures that the power switching element 5 remains open.

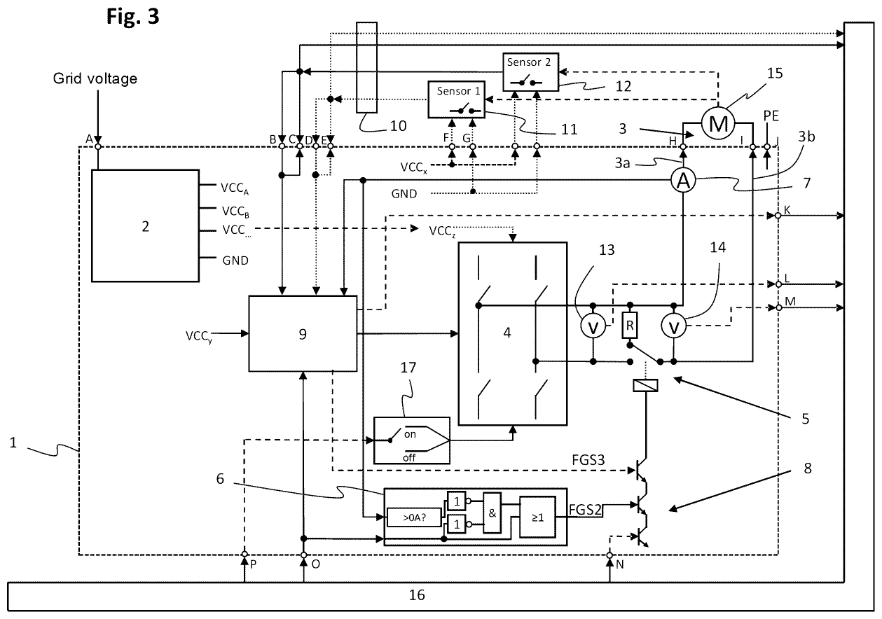

The switching or enable signals “Release”, “Safety ok2” and “Safety ok1” preferably originate from a superordinate controller (PLC), cf. FIGS. 2 and 3.

The solution according to the invention shown in FIG. 1 results in a system architecture for setting up fail-safe controllers or control devices without the direct influence of software/firmware or of microcontrollers. A 3-stage, μC-independent and thus software-free enable-signal concept is introduced that serially monitors the control of an actuator, e.g. a clamping unit, for leaving a safe state and for transferring it into an enabled and thus in principle unsafe state:

A first stage comprises the closing or enabling of a solid-state relay (in the power part 4) by means of the (fourth) enable signal “Safety ok1”. A second stage comprises the closing or enabling of a switching relay (of the power switching element 5) by means of at least one enable signal (“Safety ok2” and/or FGS3). A third step comprises the closing or enabling of the switching relay on the basis of logical operations between the flowing current (measured by the sensor means 7) and the present switching signal by means of the further enable signal FGS2.

FIG. 2 shows a more detailed circuit diagram of the control device 1 according to the invention from FIG. 1 with a connected actuator (electric motor) 15 and a superordinate controller (PLC) 16. Otherwise, in the figures, the same reference signs denote identical or at least identically acting elements.

Only the essential distinctive features according to FIG. 2 are discussed in more detail below:

The power source 2 is connected to a grid voltage (AC voltage) via the connection A. Said power source generates various DC voltages VCC_{A}, VCC_{B}, VCC . . . ( . . . =x, y, z) therefrom and outputs them, e.g. in order to supply power to the microcontroller 9 (with VCC_{y}). GND stands for ground.

The reference signs B to P denote further connections of the control device 1. Specifically, the connections H and I correspond to the output connection 3 in FIG. 1 (connection conductors 3a, 3b). The enable signal “Safety ok2” is applied to the connection N (cf. FIG. 1). The switching signal “Release” is applied to the connection O (cf. FIG. 1). The (fourth) enable signal “Safety ok1” is applied to the connection P (cf. FIG. 1). All the last-mentioned signals originate from the PLC 16.

Arranged between the connection P and the power part 4 is a further separating element 17 which, in accordance with the switching signal at connection P, switches (activates or deactivates) the power part 4 on or off.

Reference sign 7 in turn denotes the already mentioned sensor means for monitoring the output current (here illustrated as an ammeter), which in the present case is arranged downstream of the power switching element 5.

The further signal (fault signal) “Fault” is output to the PLC at the connection K, cf. FIG. 1. The sensor signal from the sensor means 13 (voltmeter) is output at the connection L; the sensor signal from the sensor means 14 (voltmeter) is output at the connection M, cf. FIG. 1.

The position sensors 11, 12 detect a place or position of the actuator 15. The relevant position signals are duplicated and provided both to the microcontroller 9 and to the PLC 16.

FIG. 2 explicitly shows a preferred configuration of the monitoring circuit 6 which comprises at least one software-free electrical logic assembly 6a in the form of a combinational circuit. This logic assembly 6a is designed to carry out logic operations between the switching state of the switching signal (at the connection O) and the electrical power, or the associated current flow, determined by the sensor means 7. The result of the operation is used to generate at least one further enable signal, FGS2, as already described. This further enable signal FGS2 is able to be used to act on the power switching element 5 via the switching means 8 (in the present case an arrangement of a plurality of transistors to which the enable signal from the connection N is also applied).

In the present case, the logic assembly 6a comprises, by way of example and without this being limiting, the following elements (software-free logic gates): An element 6aa for determining whether the mentioned current flow is >0 A; two NOT gates 6ab, 6ac operatively connected to the element 6aa and to the connection O, respectively; an AND gate 6ad for the outputs of the two NOT gates 6ab, 6ac; and a NOR (NOT OR) gate 6ae for the output of the AND gate 6ad and the signal at the connection O. Hence, FGS2=1 (HIGH) even if the switching signal at the connection O=1 (HIGH). If the switching signal at the connection O=0 (LOW), FGS2 is only HIGH when the sensor means 7 measures no current flow. If, despite the fact that the switching signal at the connection O=0 (LOW), a current flows, a fault is present and the power switching element 5 remains open (no power at 3).

It is pointed out again here that none of the switching/enable signals mentioned so far is processed by the microcontroller 9. In addition, physical separation between the actuator system (actuator 15) and the control device 1 can advantageously be made possible via the enable signals. Redundant feedback signals of the power path for the monitoring thereof are likewise not influenced by the microcontroller 9. This integrated microcontroller 9 adds to the functionality exclusively with non-safety-relevant features, such as, e.g., a lifetime analysis, wear (condition) monitoring, evaluation of switching times, etc.

The integration of power-path monitoring mentioned above preferably includes voltage detection downstream of the solid-state relay or of the power part 4 (sensor means 13, connection L), voltage detection downstream of the switching relay or of the power switching element 5 (sensor means 14, connection M) and current measurement in the power path to the actuator system (actuator 15) by means of the sensor means 7.

FIG. 3 shows a more detailed circuit diagram of a further control device 1 according to the invention, again with a connected actuator 15 and PLC 16.

In addition to the configuration in FIG. 2, the control device 1 comprises a further signal connection (depicted as a dashed line) between the microcontroller 9 and the switching means 8 (in the present case an arrangement composed of three transistors to which the enable signal from the connection N and the further enable signal FGS2 from the monitoring circuit 6 are also applied) which is able to act on the power switching element 5.

In the exemplary embodiment shown, the microcontroller 9 is designed to generate, on the basis of its operating state, at least one more additional enable signal FGS3, which additional enable signal FGS3 is able to be used to act on the power switching element 5 via the mentioned switching means 8. The electrical power at the output connection 3 is only switched on when both the enable signal (at the connection N) and the further enable signal FGS2 as well as the additional enable signal FGS3 each command a corresponding switching state of the power switching element 5. This will, e.g., not be the case when the microcontroller 9 is not operationally ready (because, e.g., the voltage VCC_{y} is not present).

The position sensors 11, 12 in FIGS. 1 to 3 are connected to the control device 1 via two or four input connections B-E. The mentioned connections serve to read in and capture two position signals, one per sensor 11, 12, the two position signals indicating an actual position of the actuator 15 (cf. FIGS. 2 and 3) with redundance.

The microcontroller 9 is designed to generate a further signal (fault signal) which is output at the connection K, as has already been mentioned. This can be done on the basis of a logical combination, in particular an XOR combination or an XNOR combination, of switching states of the two position signals (at B, C or D, E). In this way, when switching, it can be checked whether one of the position sensors 11, 12 is defective. If, e.g., (without this being limiting) the signal from sensor 1 (reference sign 11)=1 (HIGH), provision can be made for it to have to be that the signal from sensor 2 (reference sign 12)=0 (LOW). If, conversely, Sensor 1=0 (LOW), it must then be that Sensor 2=1 (HIGH). The position sensors 11, 12 are thus preferably identical but always have to deliver the opposite values (0/1 or 1/0). If the case then occurs whereby both values are 0/0 or 1/1, one of the position sensors 11, 12 is defective and a corresponding fault signal is output at K.

FIG. 3 thus shows the optional extension of the invention to a 4-stage enable concept: The integrated microcontroller 9 is involved in the safety path with its (own) additional enable signal FGS3 in the power path. It is thereby possible to confirm, e.g., safe start-up or the general operational readiness of the microcontroller 9. The microcontroller 9 is furthermore not involved in safety-relevant functions, however.

Generally, the integrated microcontroller 9 processes exclusively non-safety-relevant functions within the scope of industry 4.0, communication, generation of the mentioned fault signal at K through extensive SW analysis and output and communication in the case of a fault, e.g. in the case of a power failure.

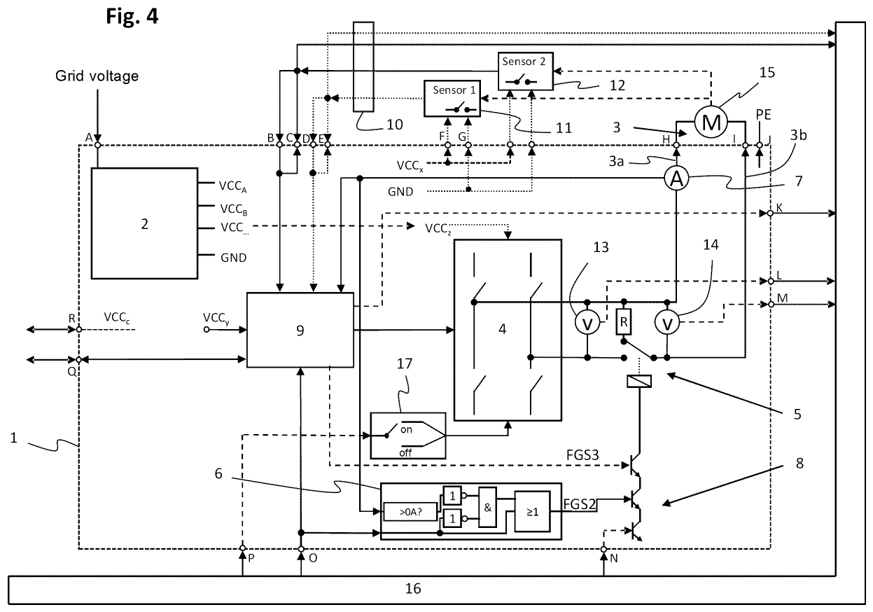

FIG. 4 fundamentally shows the same configuration of the control device as FIG. 3, with the exception of the additional external connections Q and R. Connection Q is operatively connected to the microcontroller 9, for example in order to program or parameterize it. The connection Q is, e.g., a USB connection (preferably USB-C); however, other connection types are also possible, e.g. an implementation as a COM port (Sub-D-9).

Connection R supplies the control unit (microcontroller 9) with a voltage of preferably 24 V or signals the functioning of the control unit via a corresponding voltage signal. The voltage VCC_{c} at the connection R is preferably not applied directly to the microcontroller 9 but rather the microcontroller 9 is supplied with a voltage VCC_{y} of 5 V or 3.3 V, i.e. with a voltage derived from VCC_{c}. The external connection R thus also serves in particular for tapping internally generated voltages for the external analysis of a voltage supply and/or voltage conversion within the control device 1.

1. A control device (1) for fail-safe control of an electric actuator (15), the control device comprising:
a source (2) of electrical power;
at least one power path from the source (2) of electrical power to an output connection (3) for an actuator (15), at least one power part (4) arranged in said power path, said power part (4) is designed to at least one of switch a polarity of a voltage present at the output connection (3) or to change the amount of an electrical power provided at the output connection (3);
at least one power switching element (5) arranged in the power path, the at least one power switching element (5) is designed to switch the electrical power provided at the output connection (3) on and off;
at least one sensor (7) arranged downstream of the power switching element (5) in order to determine the electrical power currently provided at the output connection (3);
a first signal input (N) for an enable signal (Safety ok2) for actuating the power switching element (5);
a second signal input (O) for a switching signal (Release) for providing the electrical power at the output connection (3) based on a switching state of the enable signal (Safety ok2);
at least one software-free electrical logic assembly (6a) comprising a combinational circuit, which is designed to carry out logic operations between the switching state of the switching signal (Release) and the electrical power determined by the sensor (7) and consequently to generate at least one further enable signal (FGS2), which further enable signal (FGS2) is able to be used to act on the at least one power switching element (5).

2. The control device (1) as claimed in claim 1, wherein
the electrical power at the output connection (3) is only switched on when both the enable signal (Safety ok2) and the further enable signal (FGS2) each command a corresponding switching state of the power switching element (5).

3. The control device (1) as claimed in claim 1, wherein
the power switching element (5) comprises at least one electromechanically, electrically or purely mechanically operative separating element, which is integrated into the power path, and is adapted to interrupt a power supply to the output connection (3), the at least one separating element being adapted to be monitored with respect to the switching state from outside the control device (1) by at least one downstream sensor (14) by virtue of relevant sensor connections being led out from the control device (1) to the outside.

4. The control device (1) as claimed in claim 1, further comprising
at least one evaluation unit (9) which is configured to receive the switching signal (Release) and a corresponding switching time, to provide the power with a temporal profile at the output connection (3) and to generate at least one more additional enable signal (FGS3) based on an operating state of the evaluation unit (9), and the additional enable signal (FGS3) is adapted to be used to act on the at least one power switching element (5).

5. The control device (1) as claimed in claim 4, wherein
the electrical power at the output connection (3) is only switched on when both the enable signal (Safety ok2) and the further enable signal (FGS2) as well as the additional enable signal (FGS3) each command a corresponding switching state of the power switching element (5).

6. The control device (1) as claimed in claim 4, wherein
the evaluation unit (9) is adapted to process exclusively non-safety-relevant functions, the functions implemented by software and/or algorithms being adapted to be deactivated at any time by taking away the enable signal (Safety ok2).

7. The control device (1) as claimed in claim 4, wherein
the evaluation unit (9) is adapted to generate the one more additional enable signal (FGS3) in order to signal operational readiness and/or by switching off the power, in cases of faults.

8. The control device (1) as claimed in claim 4, wherein
the evaluation unit (9) is adapted to generate at least one further signal (Fault), and to provide the at least one further signal (Fault) to a relevant output (K) in order to make any faults available outside of the control device (1).

9. The control device (1) as claimed in claim 4, wherein
the evaluation unit (9) is designed to act on the power part (4), in order to generate via the power part (4) a time-dependent power to be provided at the output connection (3), the time-dependent power being adapted to be used to transfer the actuator (15) into at least one target position and to subsequently hold the actuator (15) in the target position.

10. The control device (1) as claimed in claim 9, further comprising
at least one external connection (Q) operatively connected to the evaluation unit (9) in order to program and/or to parametrize the evaluation unit (9) via the at least one external connection (Q), and to thus adjust the time-dependent power in order to allow the actuator (15) to be switched on and switched off in an application-specific manner.

11. The control device (1) as claimed in claim 8, further comprising
at least one input connection (B-E) for reading in and capturing a position signal which indicates an actual position of the actuator (15), in order to generate the further signal (Fault) based thereon.

12. The control device (1) as claimed in claim 11, further comprising
at least two input connections (B-E) for reading in and capturing two position signals, the two position signals indicating an actual position of the actuator (15) with redundance,
whereby the evaluation unit (9) is designed to generate the further signal (Fault) based on a logical combination of the switching states of the two position signals.

13. The control device (1) as claimed in claim 1, further comprising
at least one external connection (R) for tapping internally generated voltages for external analysis of a voltage supply and/or voltage conversion within the control device (1).

14. The control device (1) as claimed in claim 1, wherein
the power part (4) comprises an H-bridge circuit (4a) or an H bridge with semiconductor switches.

15. The control device (1) as claimed in claim 1, wherein
the power part (4) for controlling a three-phase actuator comprises a triple H-bridge circuit or a triple H bridge with semiconductor switches.

16. The control device (1) as claimed in claim 1, wherein
the power switching element (5) is connected between the power part (4) and the output connection (3).

17. The control device (1) as claimed in claim 1, further comprising
a third signal input (P) for a fourth enable signal (Safety ok1) for activating or deactivating the power part (4).

18. The control device (1) as claimed in claim 11, wherein
the input connection or the input connections (B-E) are adapted to duplicate the position signal of a respectively connected position sensor (11, 12) in order to make a duplicated position signal available for an external control unit (16).

19. A system comprising: a control device (1) as claimed in claim 1 and the actuator (15) connected to the output connection (3).

20. The system as claimed in claim 19, further comprising
an external control unit (16) operatively connected to the control device (1) for providing the enable signal (Safety ok2) to the first signal input (N) and the switching signal (Release) to the second signal input (O).

21. The system as claimed in claim 19, wherein
the system is configured to perform, by way of sensors present in the power path, integrated switching-state monitoring via inductance measurements in the connected actuator (15) using a superposed frequency on an output voltage at the output connection (3) and a resulting frequency on an associated current signal to give inductance measurements.
